(19) United States
(12) Patent Application Publication
(10) Pub. No.: US 2025/0308360 A1
(43) Pub. Date: Oct. 2, 2025

(54) METHODS AND SYSTEMS FOR LOCATING AN ASSET IN AND NEAR AN INDOOR ENVIRONMENT

(71) Applicant: RIOH INC., Mirabel (CA)

(72) Inventors: Simon Rousseau, Mirabel (CA); Dan Rousseau, Mirabel (CA)

(73) Assignee: RIOH INC., Mirabel (CA)

(21) Appl. No.: 19/093,025

(22) Filed: Mar. 27, 2025

Related U.S. Application Data
(60) Provisional application No. 63/571,035, filed on Mar. 28, 2024.

(51) Int. Cl. G08B 13/24; G01S 13/88

(52) U.S. Cl. CPC G08B 13/2462; G01S 13/88

(57) ABSTRACT

Asset localization solutions are provided. They allow a signal-emitting device to be reached an accuracy of less than one metre in an indoor environment and in nearby associated locations with a small number of antennae. The solution is technologically agnostic with respect to the type of receiver and/or transmitter used. A system for assisting a user in locating an asset including a transmitter that emits a signal includes a real time locating system (RTLS) and a locator device. The RTLS provides an approximate location of the asset based on a first signal characteristic measured by its receivers. The locator device provides a more precise indication based on a second signal characteristic measured by its receivers and conveys it to the user through its output devices.

### CROSS-REFERENCE TO RELATED APPLICATION

This application claims the benefit of and priority to U.S. Provisional Patent Application No. 63/571,035, filed Mar. 28, 2024, and entitled “METHODS AND SYSTEMS FOR LOCATING AN ASSET IN AND NEAR AN INDOOR ENVIRONMENT,” the disclosure of which is hereby incorporated by reference in its entirety.

### TECHNICAL FIELD

The technical field relates to asset tracking, and more specifically to systems and methods for assisting a user in locating an asset comprising a transmitter configured to emit a signal.

### BACKGROUND

The ability to track the location of assets with high precision in large indoor environments, whether spanning single or multiple floors, or even distributed across multiple buildings, possibly on an international scale, is essential to ensuring that items or pieces of equipment can be found quickly, easily and accurately. This is particularly important when such assets must be serviced, used or consumed without delay. However, deploying a telecommunications infrastructure capable of enabling the geolocation of mobile equipment or objects based on existing techniques requires substantial investment.

A variety of telecommunication technologies are currently used to implement indoor geolocation solutions, including, for example, Wi-Fi™, Bluetooth™, Bluetooth™ Low Energy (BLE™), Ultra-Wideband (UWB), Radio-Frequency Identification (RFID), infrared (IR) and LiDAR. Each of these technologies presents its own advantages and limitations, and in some cases, multiple technologies can be combined to address different operational or environmental requirements.

In most cases, indoor geolocation relies on the transmission, reception and analysis of telecommunication signals that fall within frequency ranges defined by prevailing industry standards, such as IEEE 802.11, 802.11mc, 802.11ax, 802.15.3 and 802.15.4a, among others. Determining the location of an asset in indoor and/or outdoor environments using these technologies typically requires knowledge of the position of one or more reference points. These reference points can be used in conjunction with various signal analysis techniques such as triangulation, trilateration, fine time measurement (FTM), angle of arrival (AoA) and signal strength-based estimation, e.g., based on RSSI.

Technologies capable of providing high-precision localization, e.g., with an accuracy margin of 3 to 5 metres or less, typically require the installation and positioning of a dense array of receiving antennae capable of capturing sufficient signal information with a quality necessary to support these analytical techniques. For example, in certain hospital settings, achieving an adequate level of localization accuracy has been shown to require a density of approximately one reference antenna per 600 to 800 square feet. Scaling such infrastructure to cover large environments, e.g., spanning 50,000 square feet or more, presents significant logistical and financial challenges.

Another technical challenge arises in systems that rely on radio beacons, such as BLE™ beacons, which typically broadcast advertisement packets over multiple radio channels. For example, BLE™ advertisement packets are cyclically transmitted over three distinct advertising frequencies. Because radio wave propagation characteristics can vary between frequencies, the RSSI associated with a signal received on one frequency can differ substantially from that of a signal on another frequency, even if emitted at the same power level and from the same location. As a result, averaging the RSSI across all channels can lead to degraded localization accuracy. However, the advertisement packets may not include any indication of the frequency over which they were transmitted. Consequently, the receiving system has no inherent means of determining the transmission channel, limiting the ability to selectively filter or weight RSSI data based on channel-specific characteristics.

### SUMMARY

There remains a need for improved indoor asset tracking systems that can reduce infrastructure costs, operate with limited antenna density, and/or address the ambiguity introduced by multi-frequency signal emission, nonetheless providing accurate and robust position estimation. The present disclosure provides solutions which allow for asset localization accuracy in operational mode, making it possible to reach an asset equipped with a signal-emitting device to an accuracy of less than one metre in an indoor environment and/or in associated locations near the indoor environment with a small number of antennae. The solution is technologically agnostic with respect to the type of receiver and/or transmitter used.

In accordance with an aspect, a system for assisting a user in locating an asset comprising a transmitter configured to emit a signal is provided. The system includes a real time locating system (RTLS) adapted to provide an approximate location of the asset to the user, which includes: at least one RTLS receiver, each adapted to receive the signal and to measure a first characteristic of the signal, and at least one processor configured to receive from each of the at least one RTLS receiver the measured first characteristic and to determine therefrom an approximate location of the asset. The system also includes a locator device adapted to provide a precise indication for locating the asset to the user, which includes: at least one receiver, each adapted to receive the signal and to measure a second characteristic of the signal, at least one processor configured to receive from each of the at least one receiver the measured second characteristic and to compute therefrom the precise indication for locating the asset, and at least one output device adapted to convey the precise indication for locating the asset to the user. In the system, an accuracy radius of the precise indication is less than an accuracy radius of the approximate location.

In accordance with another aspect, a method for assisting a user in locating an asset comprising a transmitter configured to emit a signal is provided. The method includes: receiving, by at least one receiver of a real time locating system (RTLS), the signal; measuring, by the at least one receiver of the RTLS, a first characteristic of the signal; determining, by at least one processor of the RTLS, an approximate location of the asset based on the first characteristic; transmitting, by the RTLS, the approximate location of the asset; receiving, by a user device, the approximate location; outputting, by the user device, a first indication for locating the asset based on the approximate location; when a locator device is within range of the signal, receiving, by at least one receiver of the locator device, the signal; measuring, by the at least one receiver of the locator device, a second characteristic of the signal; and outputting, by the locator device, a second indication for locating the asset based on the second characteristic. In the method, an accuracy radius of the second indication is less than an accuracy radius of the first indication.

In accordance with a further aspect, a system for assisting a user in locating an asset comprising a transmitter configured to emit a signal through a two-stage process is provided. the system includes a real time locating system (RTLS) adapted to provide an approximate location of the asset to the user in a first stage and a locator device adapted to provide a precise indication for locating the asset to the user in a second stage. The RTLS includes at least one RTLS receiver adapted to receive the signal and to measure a first characteristic of the signal, and at least one processor configured to receive from the at least one RTLS receiver the measured first characteristic and to determine therefrom an approximate location of the asset. The locator device includes at least one receiver adapted to receive the signal and to measure a second characteristic of the signal and to cause the process to enter the second stage in response to the transmitter of the asset entering detection range, at least one processor configured to receive from each of the at least one receiver the measured second characteristic and to compute therefrom the precise indication for locating the asset, and at least one output device adapted to convey the precise indication for locating the asset to the user. An accuracy radius of the precise indication is less than an accuracy radius of the approximate location.

In accordance with yet another aspect, a two-stage method for assisting a user in locating an asset comprising a transmitter configured to emit a signal is provided. The method includes a first stage and a second stage. In the first stage, the method includes receiving, by a real time locating system (RTLS), the signal, measuring, by the RTLS, a first characteristic of the signal, determining, by the RTLS, an approximate location of the asset based on the first characteristic, transmitting, by the RTLS, the approximate location of the asset, receiving, by a user device, the approximate location, and outputting, by the user device, a first indication for locating the asset based on the approximate location. The second stage is automatically initialized when a locator device is within detection range of the signal. In the second stage, the method includes receiving, by the locator device, the signal, measuring, by the locator device, a second characteristic of the signal, and outputting, by the locator device, a second indication for locating the asset based on the second characteristic. An accuracy radius of the second indication is less than an accuracy radius of the first indication.

In accordance with yet a further aspect, a non-transitory computer-readable medium is provided. The computer-readable medium has instructions stored thereon which, when executed by one or more processors of a locator device, cause the one or more processors to perform a first stage and a second stage. In a first stage, the instructions cause the one or more processors to receive an approximate location of an asset from a real time locating system (RTLS) configured to estimate the approximate location based on a first characteristic measured by the RTLS in a signal emitted by a transmitter of the asset, and output a first indication for locating the asset based on the approximate location. The instructions cause the one or more processors to enter a second stage in response to the transmitter of the asset entering detection range of the locator device. In the second stage, the instructions cause the one or more processors to receive the signal, measure a second characteristic of the signal, and output a second indication for locating the asset based on the second characteristic, wherein an accuracy radius of the second indication is less than an accuracy radius of the first indication.

In accordance with yet another aspect, a real time locating system (RTLS) for locating an asset comprising a transmitter configured to broadcast radio signals over N channels, wherein N >1, is provided. The RTLS includes at least one receiver adapted to survey the radio signals during a configurable time period and to measure a characteristic of the radio signals, and at least one processor configured to receive from the at least one receiver the measured characteristic, categorize the signals in N categories based on the characteristic, and estimate a location of the asset based on at least one signal associated with one of the N categories.

In accordance with yet a further aspect, a method for locating an asset comprising a transmitter configured to broadcast radio signals over N channels, wherein N>1, is provided. The method includes surveying the radio signals during a configurable time period and measuring a characteristic of the radio signals, categorizing the signals in N categories based on the characteristic, and estimating a location of the asset based on at least one signal associated with one of the N categories.

In accordance with yet a further aspect, a non-transitory computer-readable medium is provided. The computer-readable medius has instructions stored thereon which, when executed by one or more processors, cause the one or more processors to survey radio signals broadcast by a transmitter of an asset over N channels, wherein N>1 during a configurable time period and measure a characteristic of the radio signals, and categorize the signals in N categories based on the characteristic, and estimate a location of the asset based on at least one signal associated with one of the N categories.

Other features and advantages of the method and system described herein will be better understood upon a reading of preferred embodiments thereof with reference to the appended drawings. Although specific features described in the above summary and in the detailed description below may be described with respect to specific embodiments or aspects, it should be noted that these specific features can be combined with one another unless stated otherwise.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment.

FIG. 1A is a schematic of a system for assisting a user in locating an asset, in accordance with an embodiment.

FIG. 1B is a diagram of a use case of the system of FIG. 1A, in accordance with an embodiment.

FIG. 1C is a schematic of the system of FIG. 1A during a first stage, in accordance with an example and an embodiment.

FIG. 1D is a schematic of the system of FIG. 1A during a second stage, in accordance with an example and an embodiment.

FIG. 1E is a diagram a data flow of the system of FIG. 1A, in accordance with an embodiment.

FIG. 2A is a flowchart of a method for assisting a user in locating an asset, in accordance with an embodiment.

FIG. 2B is a flowchart of a method for selecting an advertisement channel, in accordance with an embodiment.

FIG. 2C is an illustration of received signal strength indicators broadcast by radio emitters over time, in accordance with an example and an embodiment.

FIGS. 3A, 3B, 3C, 3D, 3E, 3F, 3G, 3H, 3I, 3J, 3K, and 3L are illustrations of views associated with a graphical user interface of a locator device included in the system of FIG. 1A, in accordance with an embodiment.

### DETAILED DESCRIPTION

It will be appreciated that, for simplicity and clarity of illustration, where considered appropriate, reference numerals may be repeated among the Figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practised without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

The terms “a”, “an” and “one” are defined herein to mean “at least one”, that is, these terms do not exclude a plural number of items, unless stated otherwise.

Terms such as “substantially”, “generally” and “about”, that modify a value, condition or characteristic of a feature of an exemplary embodiment, should be understood to mean that the value, condition or characteristic is defined within tolerances that are acceptable for the proper operation of this exemplary embodiment for its intended application.

Unless stated otherwise, the terms “connected” and “coupled”, and derivatives and variants thereof, refer herein to any structural or functional connection or coupling, either direct or indirect, between two or more elements. For example, the connection or coupling between the elements may be acoustical, mechanical, optical, electrical, thermal, logical, wireless, or any combinations thereof.

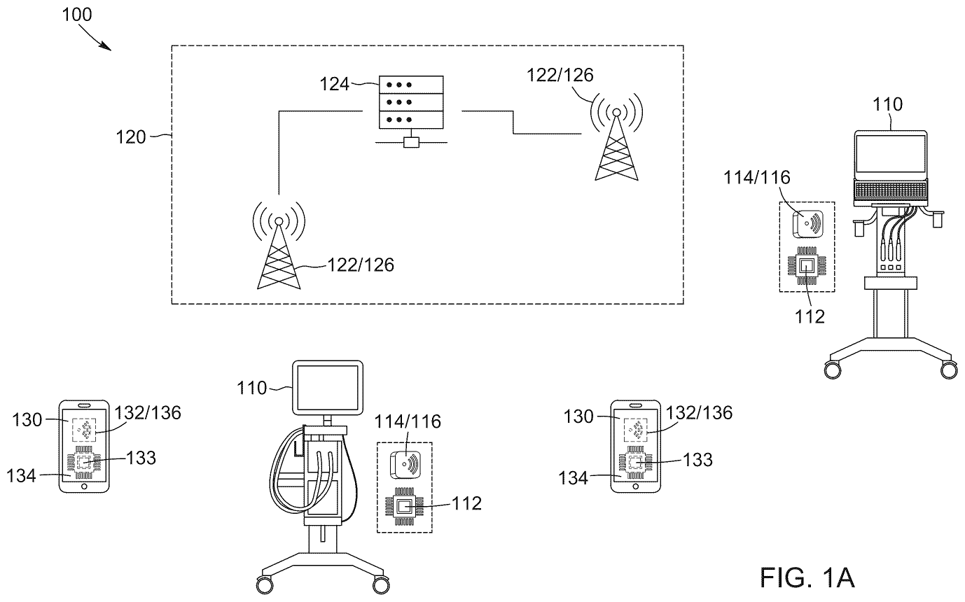

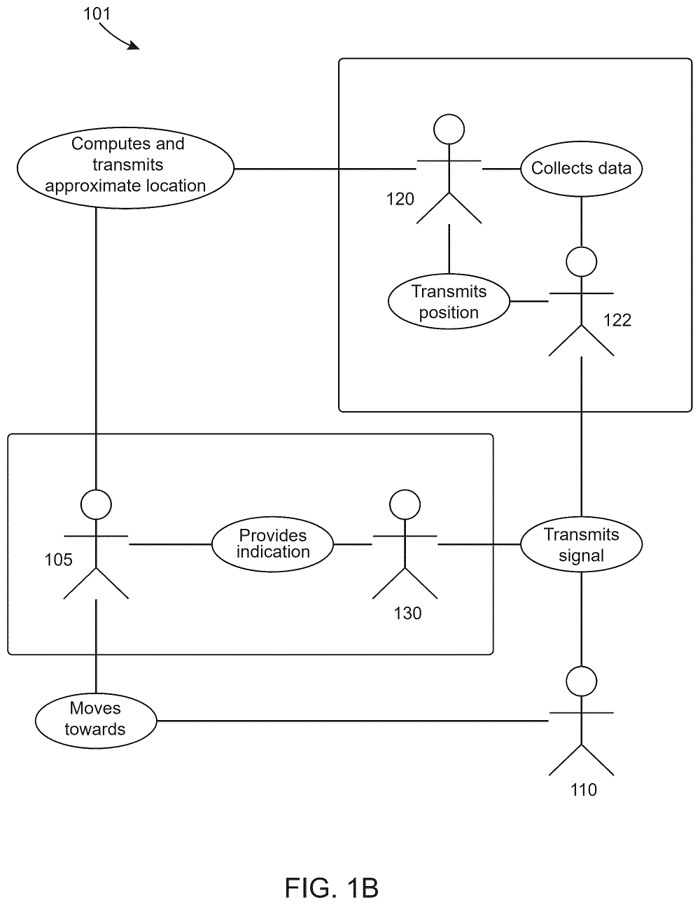

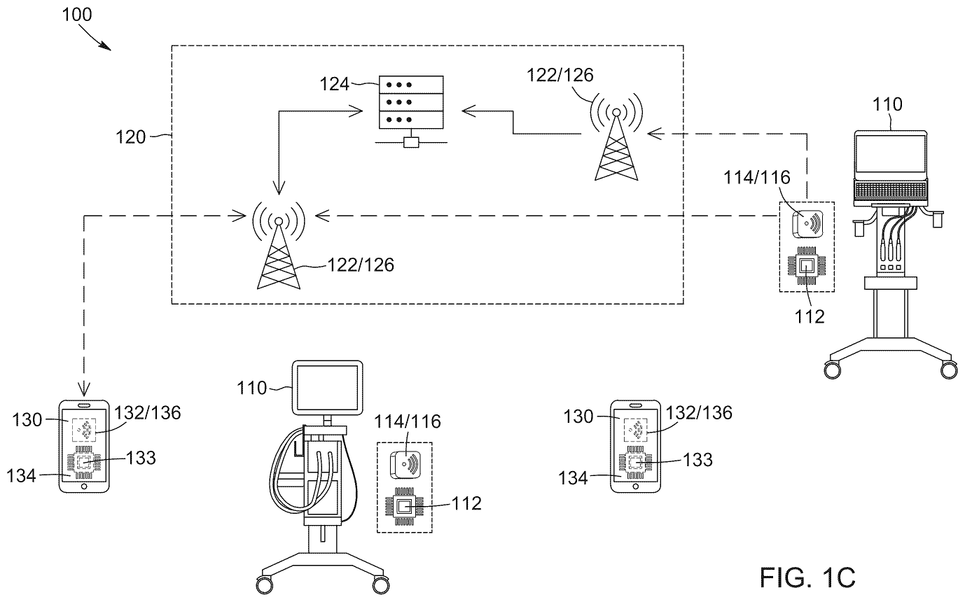

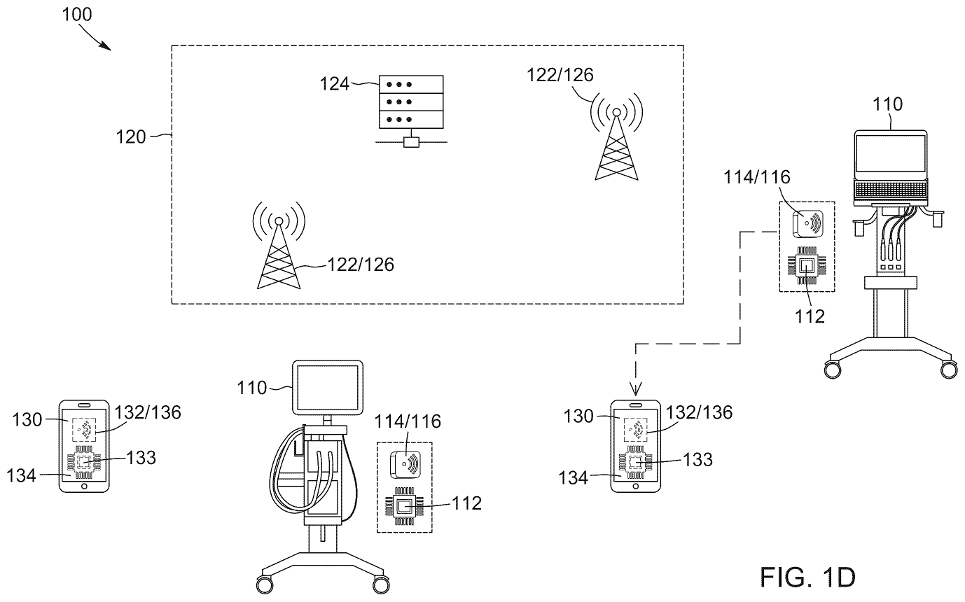

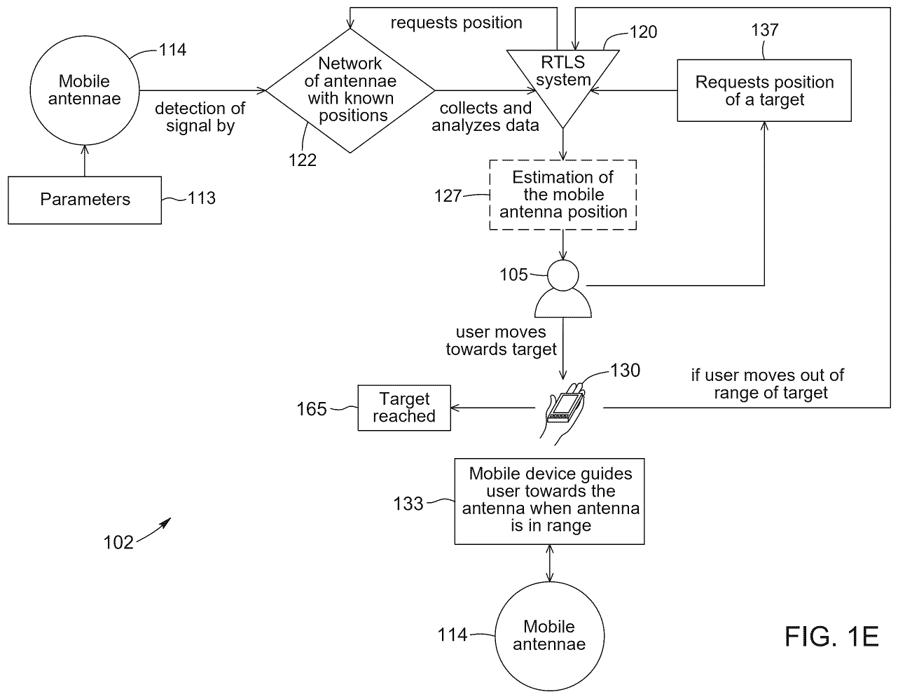

With reference to FIG. 1, an exemplary system 100 for assisting a user in locating an asset through a two-stage process is shown. Broadly described, the system 100 comprises assets 110, a real time locating system (RTLS) 120, and locator devices 130. During the first stage of the process, the RTLS 120 is used to generate an indication of the approximate location of an asset 110, which the user can employ to move towards the vicinity of the asset 110. When the locator device 130 reaches a location that makes the asset 110 within its detection range, the system 100 can automatically switch to the second stage, in which an indication of the precise location of the asset 110 is conveyed to the user.

Because locator devices 130 are adapted to present the user with a precise indication to locate an asset 110, it is sufficient for the RTLS 120 to provide a relatively more approximate location of the asset 110. This advantageously makes it possible to use a RTLS 120 in providing metre-level precision asset tracking with fewer antennae than would otherwise be possible. This can make it possible to improve a decentralized, autonomous asset tracking system by leveraging a scalable and modular RTLS 120 that can be grown or shrunk with available resources and can simultaneously support multiple communication technologies such as BLE™, UWB, Wi-Fi™ and/or RFID without relying on a single infrastructure, allowing asset detection even when out of direct range of a detector device 130. Conversely, adding the disclosed locator devices 130 to an existing RTLS 120 can allow asset tracking to function in both indoor and near-indoor environments, allowing tracking even outside of the coverage zones of the RTLS 120, e.g., outside Wi-Fi™ access point coverage zones.

Assets 110 can include for instance a number of objects, pieces of equipment and consumable items associated with an indoor environment and/or areas related to and near an indoor environment, and provided at various locations within the indoor environment. Of note, the location of a given asset may change over time. As an example, the indoor environment can correspond to a hospital, and assets 110 can include, but are not limited to, medical equipment such as ventilators, medical gas systems, fluid warming systems, portable imaging machines, wheelchairs, beds, forklifts, vehicles and tools. In some embodiments, each asset 110 is associated with one or more identifiers, for instance a unique identifier that is associated with one and only one asset in the system 100, including for instance a unique name and/or alias, an inventory number, a serial number and/or a unit number, and one or more additional characteristics, including for instance a type of equipment specifier, a site where the asset is held, a department which has control of the asset, a manufacturer and/or model identifier of the asset, an acquisition and/or service data and/or time, and/or any number of particularities of the asset. As further examples, the environment can include or correspond to a garage, an office building, a warehouse, and/or an indoor, outdoor or underground parking. It can be appreciated that other types of environment are possible, including any indoor place with a small to large footprint in which multiple moving assets are present and likely to be sought. Moreover, the systems and methods described herein can be extended to outdoor environments with outdoor receiving antenna (e) that could communicate to an RTLS. It can be appreciated that tracked assets can include any type of physical object, additionally or alternatively including as examples living organisms such as persons and/or animals.

Each asset 110 can include one or more tag(s) 112, transmitter(s) 114 and/or receiver(s) 116.

In some embodiments, one or more tags 112 can be affixed, e.g., be adhered, to each asset 110. The tag 112 can include at least one chip, printed control board and/or microcontroller unit configured to control at least one transmitter 114 associated with the asset 110 and cause it to emit a signal encoding information, such as a radio wave modulated to create a radio signal enabling communication at least from the transmitter 114 to suitable receivers in the system 100. In some embodiments, the tag 112 and transmitter(s) 114 operate as a beacon and transmit the radio signal at a configurable, suitable set interval, for instance every second, or every five seconds. In some embodiments, the tag 112 and/or transmitter(s) 114 are battery-powered, and the set interval can be configured to preserve battery capacity.

Each asset 110 is associated directly or indirectly with at least one transmitter 114 adapted to transmit and/or broadcast radio signals. For instance, some assets can include at least one transmitter 114, and some assets can include a tag 112 which includes at least one transmitter 114. Each transmitter 114 can include one or more antennae. As an example, a transmitter 114 associated with an asset 110 can be configured to transmit signals associated with one or more of the ultra-wideband (UWB), Bluetooth™, Wi-Fi and radio-frequency identification (RFID) radio technologies. It can be appreciated that this list is not limitative and that the described system can additionally or alternatively work with other existing or future transmission technologies. Each signal encodes at least one unique identifier allowing for identification of the associated asset 110, for instance including one or more unique identifiers of the asset 110 as described above and/or one or more unique identifiers of tag 112 and/or of the transmitter(s) 114, such as a medium access control (MAC) address. In some embodiments, each signal can encode the precise time at which the signal is emitted to a suitable granularity, e.g., in milliseconds. In some embodiments, each signal can encode additional information, including for instance information about the characteristics of the asset 110 or relevant information about the state of the asset 110, tag 112 and/or transmitter(s) 114, such as a remaining battery capacity of the battery powering the tag 112 and/or transmitter(s) 114.

In some embodiments, each asset 110 is further associated with at least one receiver 116 adapted to receive radio signals from other components of system 100 such as the RTLS 120 or locator devices 130. In some embodiments, the tag 112 can be configured such that, when a signal is received at a receiver 116 from a locator device 130 indicating that the locator device is in range of the transmitter 114, the radio signal transmission interval is temporarily reduced. It can be appreciated that some or all of the transmitters 114 can also operate as receivers 116, such that an asset 110 or a tag 112 associated with an asset 110 can include at least one transceiver 114/116, but also that some or all of the transmitters 114 can be operated merely as transmitters and that some or all of the receivers 116 can operate merely as receivers.

The system 100 includes a RTLS 120. The RTLS 120 is responsible for receiving signals from transmitters 114 associated with the assets 110 and determining therefrom an approximate location of each asset 110. When a user needs to find an asset 110, the approximate location of the asset is conveyed to the user so that they can move to the vicinity of the asset 110 with a locator device 130 adapted to providing a more precise indication of the location of the asset 110.

The RTLS can include one or more receiver(s) 122, also named RTLS receiver(s), processor(s) 124 and/or transmitter(s) 126, also named RTLS transmitter(s).

The RTLS 120 includes at least one receiver 122 adapted to receive radio signals, in particular radio signals emitted by the transmitters 114 associated with the assets 110. Therefore, the receivers 122 can be adapted to use the same technologies as the transmitters 114, e.g., UWB, Bluetooth™ and/or Wi-Fi. When receiving a radio signal from a transmitter 114, each receiver 122 is configured to measure at least one characteristic of the signal, in particular at least one characteristic relevant to determining at least an approximate location and/or distance of the asset 110 with respect to the receiver 122, such as fine time measurement, angle of arrival (AoA) and signal strength, e.g., received signal strength indicator (RSSI). Time measurements can be used to compute additional characteristics of the signal, e.g., time difference of arrival (TDOA) and/or time of flight (ToF). Information encoded in the signal can be decoded at the receiver 122 and/or transmitted encoded to at least one processor 124 of the RTLS. Signal characteristics can also be transmitted to the processor(s) 124. It can be appreciated that the accuracy of the estimated approximate location depends on the density of the network of receivers 122. Nonetheless, the system described herein does not require obtaining a highly accurate location, because the locator device 130 is able to provide indications to assist a user in finding an asset 110 that have a higher level of accuracy, e.g., have a lower accuracy radius than the approximate location estimated by the RTLS 120. In some embodiments, the RTLS 120 can therefore have only one receiver 122, or only as many receivers 122 as required to ensure that one receiver 122 is in range of each transmitter 114 associated with each asset 110. It can further be appreciated that to allow for determining an approximate location of assets, the receivers 122 need not be at a fixed location, but merely at a known location. In some embodiments, mobile receivers are configured to determine their own location using any suitable technique and transmit the same to the processor(s) 124. In some embodiments, one, some or all of the RTLS receiver(s) 122 are distinct of the receiver(s) 132 of locator devices 130 described below and can be provided at fixed location(s) in and/or near the indoor environment, e.g., by and/or on behalf of a person and/or an entity responsible for the operation and/or exploitation of the indoor environment. In some embodiments, additionally or alternatively, at least some of the locator devices 130 and/or other mobile devices associated with the indoor environment, staff and/or users can be leveraged as RTLS receiver(s) 122 and be configured to transmit information including their location, signals and/or signal characteristics to the processor(s) 124 of the RTLS 120.

The RTLS 120 includes or is associated with at least one processor 124 configured to receive information, signals and/or signal characteristics from the receiver(s) 122, and estimate an approximate location of the associated assets 110 therefrom. In some embodiments, the processor(s) 124 is part of the RTLS 120. In some embodiments, some or all of the tasks performed by the processor(s) 124 can alternatively or additionally be performed by one or more processor of one or more subsystem external to the RTLS 120, for instance, one or more purpose-built subsystem(s) each including at least one printed circuit board and/or microcontroller, general-purpose computing device(s), and/or processor(s) 133 of locator device(s) 130 as described below. It can be appreciated that different localization approaches can be used to estimate the location based on the number of receivers 122 detecting the signal associated with an asset 110. As an example, if one receiver 122 detects a signal, an approximate location of the associated asset can be estimated based, for instance, on two-way ranging, on RSSI, on ToF and/or on AoA. As another example, if at least two receivers 122 detect a signal, an approximate location of the associated asset can be estimated additionally or alternatively based, for instance, on time different of arrival (TDoA). As a further example, if at least three receivers 122 detect a signal, an approximate location of the associated asset can be estimated additionally or alternatively based, for instance, on triangulation and/or trilateration. It can be appreciated that other localization techniques can alternatively or additionally be used, including for instance proximity-based techniques and/or global navigation satellite system referrals. In some embodiments, the result of the localization can, moreover, be enhanced by using known techniques such as pattern recognition, machine learning, deep learning and/or inertial data-based techniques such as the inertial reference system.

The RTLS 120 can include at least one transmitter 126, for instance adapted to transmit the approximate position of an asset 110 of interest estimated by the processor(s) 124 to an interested party, e.g., an authorized user such as an employee of an organization deploying the system 100 that needs to locate the asset 110, for instance, to use or service it. It can be appreciated that some or all of the receiver(s) 122 can also operate as transmitters 126, such that the RTLS 120 can include at least one transceiver 122/126, but also that some or all of the receivers 122 can be operated merely as receivers and that some or all of the transmitters 126 can operate merely as transmitters. It can furthermore be appreciated that receivers 122 and transmitters 126 can implement different technologies and/or can correspond to different types of apparatuses. As an example, in some embodiments, the word “transmitter” can be used to describe a server configured to prepare payloads, e.g., network packets, including the approximate position of an asset 110 for transmission to a device of an interested party, e.g., a user device, through a communication link. For instance, the “transmitter” can be configured to prepare a number of, e.g., TCP, UDP or PLP, packets for transmission over an IP network such as the Internet and/or a different type of network, such as an X.25 network, or, if the transmitter 126 and the user device are not distant or are otherwise located on the same physical network, a local area network including wired and/or wireless links, for instance an IP, Infiniband or FibreChannel network. In some embodiments, the transmitter 126 and the user device can be connected together through a private network link. In some embodiments, the transmissions can operate through a cryptographic protocol such as the Secure Sockets Layer or the Transport Layer Security, for instance to create a virtual private network, preventing the interception of content, essentially obtaining for transmissions a security level comparable to that of a private network link.

The system 100 includes at least one locator device 130. A locator device 130 is at least responsible for providing one or more indications to assist the user for locating the asset 110 of interest once the locator device is within the range of the signal transmitted or broadcast by the transmitter 114 associated with the asset 110. In some embodiments, some or all of the locator devices 130 can be further adapted, while the locator device is not within the range of the signal, to obtain the approximate location and to provide one or more indications based on the approximate location to assist the user for locating an area where the asset is located with precision sufficient to move within range of the signal.

Each locator device can include one or more receiver(s) 132, also named radio receiver(s), processor(s) 133, output device(s) 134 and/or transmitter(s) 136, also named radio transmitter(s).

Each locator device 130 includes at least one radio receiver 132 (sometimes referred to as “radio receivers”) adapted to receive radio signals, in particular radio signals emitted by the transmitters 114 associated with the assets 110, as previously presented. Therefore, the radio receivers 132 can be adapted to use the same technologies as the transmitters 114, e.g., UWB, Bluetooth™ and/or Wi-Fi™. As with RTLS receivers 122, when receiving a radio signal from a transmitter 114, each radio receiver 132 is configured to measure at least one characteristic of the signal, in particular at least one characteristic relevant to determining at least an approximate location and/or distance of the asset 110 with respect to the receiver 132, such as fine time measurement, AoA and signal strength, e.g., RSSI.

Each locator device 130 includes at least one processor 133 configured to obtain the signal characteristic(s) measured by the radio receiver(s) 132 and compute therefrom a precise indication for locating the asset 110, i.e., a signifier that can be interpreted by the user to provide information relevant to locating the asset 110 with more precision than afforded by the approximate location provided by the RTLS 120. The precise indication can for instance make it possible for the user to move within the approximate area in which the asset 110 is located and determine whether they are getting closer to or further from the asset 110. As an example, if the signal characteristic(s) obtained can be used to compute a distance or a range of possible distances of the asset 110 to a receiver 132, e.g., 3-5 metres, 1-3 metres or <1 metre, the precise indication can include the computed distance or range of possible distances to the asset 110. As another example, if the signal characteristic(s) obtained can be used to compute an angle of the asset 110 with respect to a receiver 132, the precise indication can additionally or alternatively include a relative direction in which the asset 110 is located.

Each locator device 130 includes at least one output device 134 adapted to convey the precise indication for locating the asset 110 location computed by the at least one processor. In some embodiments, the output devices 134 include a speaker configured to provide an indication sound. As an example, different sounds and/or sound patterns can be used to convey an indication of the distance of the asset 110 to the radio receiver 132. In some embodiments, the output devices 134 additionally or alternatively include a display, for instance a screen, configured to provide a visual indication to the user. As an example, the display can be used to convey an indication of the distance and/or the direction of the asset 110 to the radio receiver 132. In some embodiments, the output devices 134 additionally or alternatively include light sources, for a number of light-emitting diodes of one or different colours, configured to provide an different type of visual indication to the user. As an example, a different number of diodes can light up to convey an indication of the distance of the asset 110 to the radio receiver 132. In some embodiments, the output devices 134 additionally or alternatively include a vibration motor configured to provide a tactile indication to the user. As an example, different vibration strengths and/or vibration patterns can be used to convey an indication of the distance of the asset 110 to the radio receiver 132.

In some embodiments, some or all of the locator devices 130 further include at least one radio transmitter 136 adapted to transmit radio signals to other components of the system 100 such as an asset 110, its associated receivers 116 and the RTLS 120. In some embodiments, the radio transmitter(s) 136 can be used to communicate with the RTLS 120 to obtain the approximate location of the asset 110, for instance for displaying it to the user. It can be appreciated that some or all of the transmitters 132 can also operate as receivers 136, such that a locator device 130 can include at least one transceiver 132/136, but also that some or all of the transmitters 132 can be operated merely as transmitters and that some or all of the receivers 136 can operate merely as receivers.

In some embodiments, the device 130 can be configured such that, when the signal of the asset 110 of interest in detected, indicating that the device 130 is in the vicinity of the asset 110, the transmitter(s) 136 emit a signal that is received by the asset receiver(s) 116, making the asset 110 and/or the asset tag 112 aware that a locator device 130 is in the vicinity, providing for the possibility for the asset 110 and/or asset tag 112 of cooperating with the locator device 130 to better assist the user in locating the asset. In some embodiments, some or all locator devices 130 can continuously emit a signal by their transmitter(s) 136, and such signal can be detected by the receiver(s) 116 associated with the asset 110. When an asset 110 and/or asset tag 112 becomes aware that a locator device 130 is in range, parameters of the signal emission by the transmitter(s) 114 can be temporarily altered. In some embodiments, the asset transmitter(s) 114 can reduce temporarily its signal emission interval, allowing the indication to update more frequently. In some embodiments, the asset transmitter(s) 114 can additionally or alternatively temporarily use a different signal emission technology, e.g., transmitting a signal of a different type. In some embodiments, the asset transmitter(s) 114 can additionally or alternatively temporarily emit a signal with more energy. This offers the benefit of making it easier and faster for the user to locate the asset 110 when the locator device 130 is in range, while avoiding energy waste, and for instance avoiding rapid depletion of batteries, when no locator devices 130 are in range. In some embodiments, some or all the assets 110 and/or asset tags 112 and locator devices 130 can be configured such that the locator device 130 transmits an indication of the asset 110 it is seeking, e.g., a unique identifier, such that only the actually sought asset 110 or its associated asset tag 112 temporarily alter emission parameters. In some embodiments, emission parameters revert to normal emission parameters after a configurable period of time has elapsed since the locator device 130 was detected. In some embodiments, emission parameters revert to normal emission parameters when the locator device 130 is no longer detected. In some embodiments, some or all locator devices 130 can be configured to transmit a signal to the asset 110 and/or asset tag 112 providing an instruction to revert to normal emission parameters, for instance because the user has located the asset 110 and intends to remain within its vicinity but does not require indications any longer.

It can be appreciated that each locator device 130 can correspond, for instance, to a purpose-built device or to a generic handheld device such as a smartphone. In the latter case, the device can include an application configured to leverage the capabilities of the device, in particular its at least one radio receiver 132 and transmitter 136 and its at least one processor. In some embodiments, the application can be configured to generate a graphical user interface (GUI) in the form of a web page consisting of code in one or more computer languages, such as HTML, XML, CSS, JavaScript and ECMAScript. In some embodiments, the GUI can be generated programmatically, for instance on a server, e.g., an HTTP server hosted by the RTLS 120, and rendered by an application such as a web browser on device 130. In other embodiments, the application can be configured to generate the GUI via a native application running on the device 130, for example comprising graphical widgets configured to render information received from the RTLS 120 and/or computed by the processor of the device 130. In some embodiments, the user interface may be accessible through a command line, through conversational text and/or through conversational voice.

It can be appreciated that although the exemplary embodiment illustrated in FIG. 1 relies on radio signals and radio transmitters, receivers and/or transceivers, the systems and methods described herein allow for different types of signals to be additionally or alternatively used. In some embodiments, some or all signals are acoustic signals, e.g., acoustic waves, and therefore transmitters can include speakers and receivers can include microphones. As an example, some or all signals can be ultrasound signals. In some embodiments, some or all signals are light signals, e.g., light waves, and therefore transmitters can include light-emitting devices such as light-emitting diodes and receivers can include photosensitive sensors such as photodiodes or photomultipliers. As an example, some or all signals can be ultraviolet signals.

With additional reference to FIG. 1B, a diagram of an exemplary use case 101 of one of system 100 is shown, in accordance with an embodiment. Broadly described, an asset 110 transmits a signal for the benefit of an RTLS 120 and a locator device 130, allowing a user 105 to move towards and eventually finds the asset 110.

The asset 110 transmits a signal, for instance, by broadcasting it for all devices in range to receive it. The asset 110 can for instance include a signal-emitting device such as a transmitter, and/or a tag including a signal-emitting device can be affixed to the device.

This signal can be received by at least one receiver 122 associated with an RTLS 120, such that the RTLS 120 is able to collect data related to the signal through its receiver 122. The data can include a unique identifier associated with the asset 110 as well as one or more of signal characteristic such as described above. In some embodiments, the receiver 122 can be a mobile receiver, and therefore can transmit its position to the RTLS 120 to allow for computations based on the signal characteristic(s) collected.

In a first stage, a user 105 using a locator device 130 may be seeking the asset 110, but the locator device 130 may not be in range of the signal transmitted by the asset 110. In this situation, the user 105 can requests localization information to the RTLS 120. Based on the data collected from the receiver 122, the RTLS 120 is able to compute an approximate location of the asset 110 and transmit it to the user 105.

With the approximate location provided by the RTLS 120, the user 105 is able to move towards the asset 110. Eventually, the locator device 130 of the user 105 will enter within the range of the asset 110, and will therefore receive the signal.

The locator device 130 moves within the detection range of the asset 110, it can automatically cause the process to switch to the second stage, transitioning from the RTLS to precise mobile-based tracking as soon as possible.

In this second stage, and as the user 105 keeps moving towards the asset 110, the locator device 130 will eventually be closer to the asset 110 than the receiver 122, and therefore the locator device 130 will be able to obtain one or more signal characteristic that will allow it to infer the location of asset 110 with a higher precision. At this point, the locator device 130 will provide an indication in order to assist the user 105 in locating the asset 110.

In some embodiments, the locator device 130 can provide an indication of the distance of the asset 110, letting the user 105 know, as they move within a space, e.g., a room, whether they are moving towards or away from the asset 110, and making locating the asset 110 similar to playing a game of “hot or cold”. In some embodiments, the locator device 130 can additionally or alternatively provide an indication of the direction in which the asset 110 can be found.

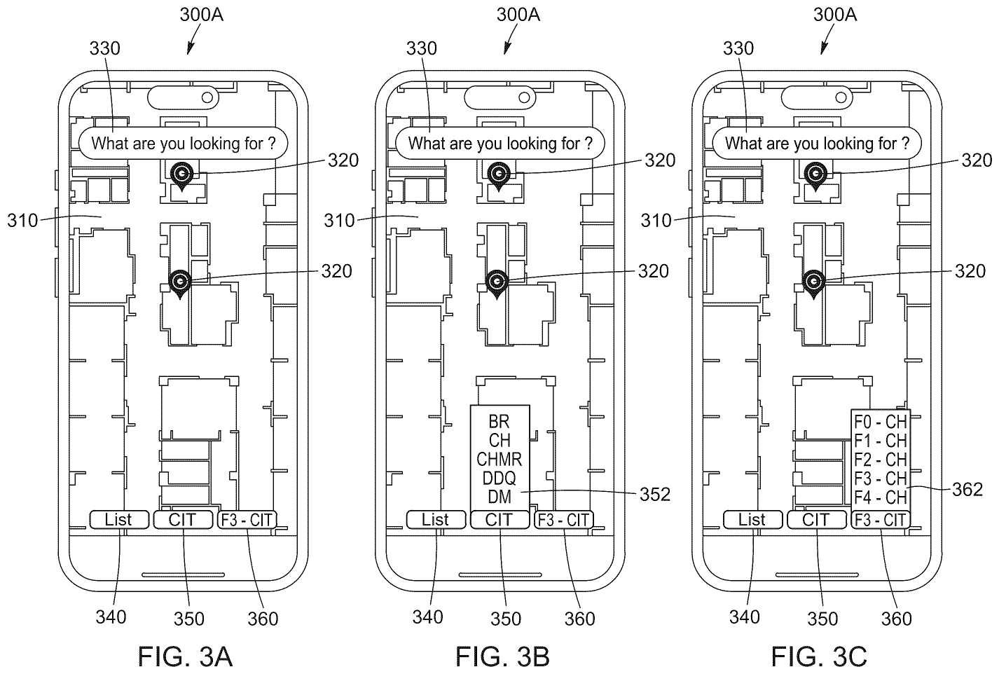

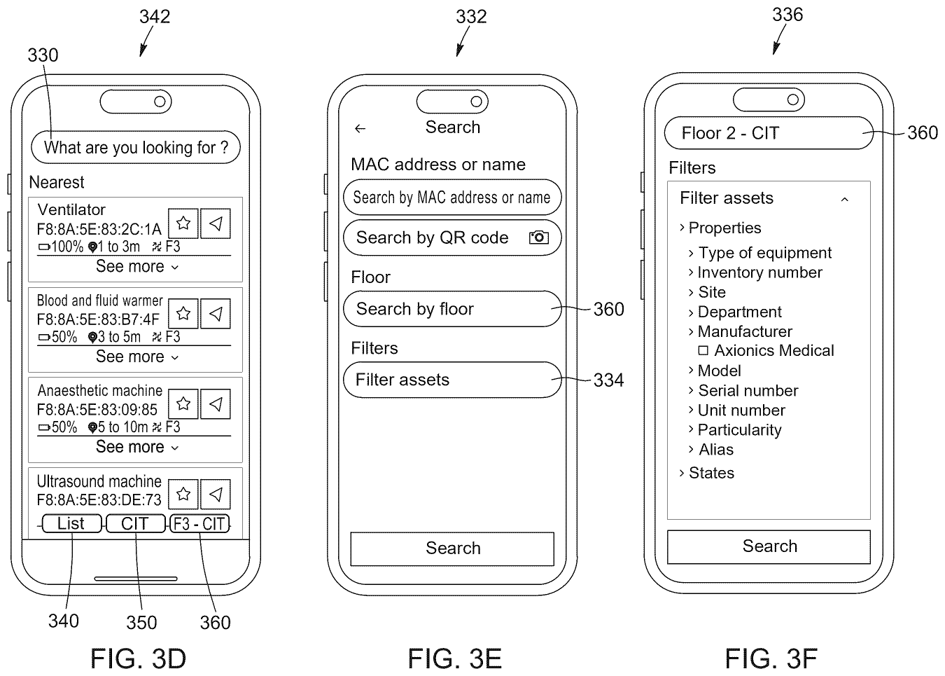

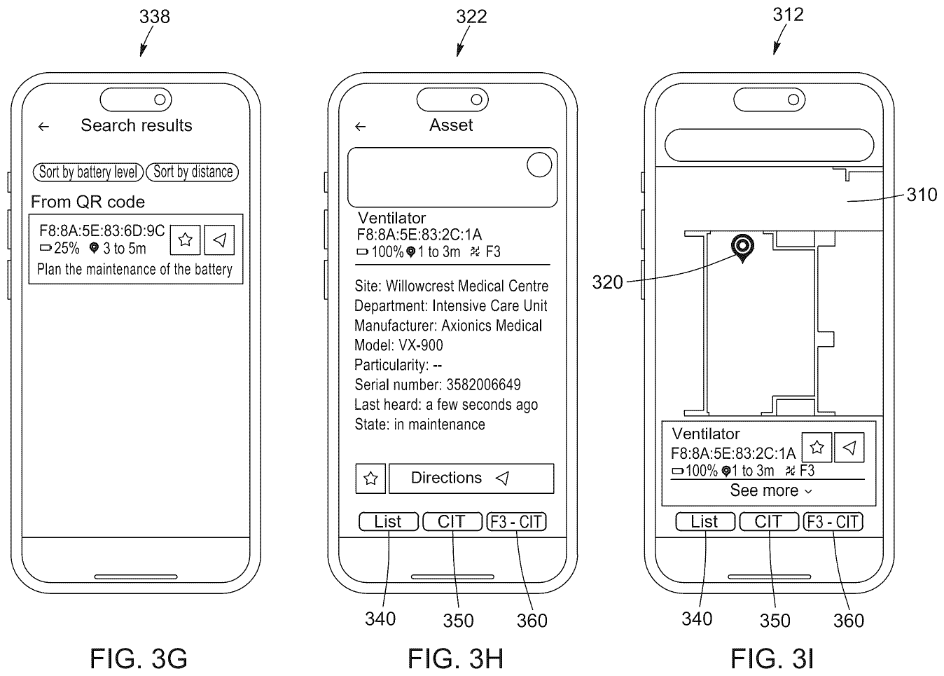

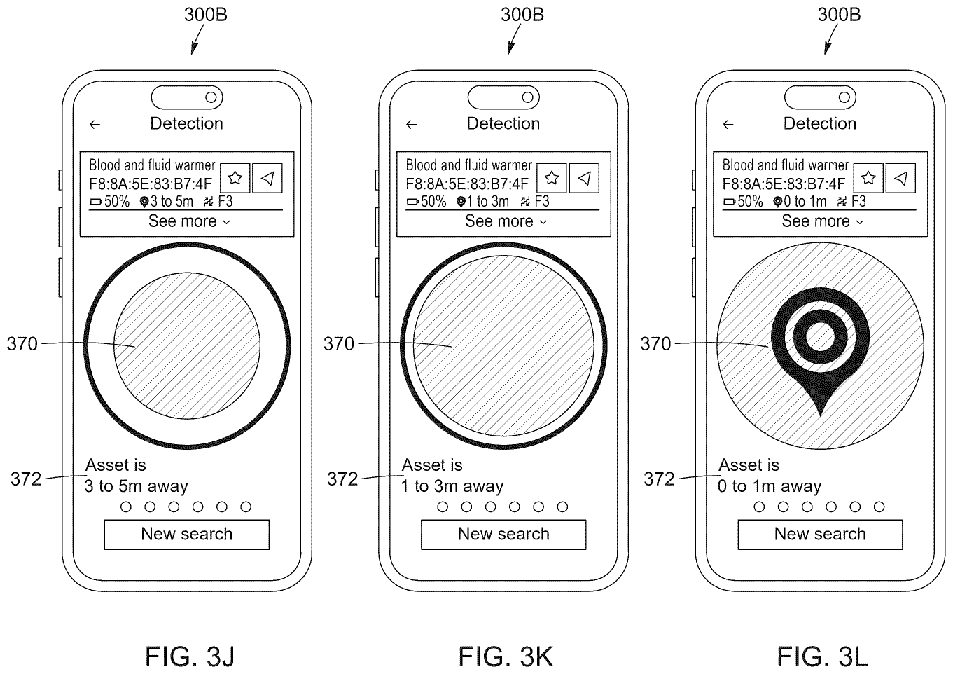

With reference to FIG. 1C, an example of the exemplary system 100 being used during the first stage is illustrated. The tag 112 associated with an asset 110 transmits, through its transmitter 114 a signal that is detected by receivers 122 of the RTLS. A signal characteristic is measured by each receiver 122 and transmitted to the processor 124, which can compute an approximate location of the asset 110 based on the signal characteristics measured by its receivers 122. One of the receiver 122 can also receive a request from a user device, e.g., a workstation or a mobile locator device 130 transmitting the request via a transmitter 136, for the approximate location of the asset 110. The processor 124 can transmit the approximate location to a transmitter 126 so that it can be forwarded to the requesting user device, e.g., via its receiver 132. The approximate location can be used to convey to the user an indication of the asset's location, for instance by producing a map-based graphical user interface on a monitor 134 of the device, for instance, as illustrated in FIGS. 3A to 3C. It can be appreciated that, although a locator device 130 is illustrated in FIG. 1C, any suitable device capable of communicating with RTLS processor 124 can be used to retrieve the approximate location of asset 110, including for instance a desktop or laptop computer connected to RTLS processor 124 directly or indirectly, via wired and/or wireless links, e.g., via Ethernet and/or an optic fibre links.

With reference to FIG. 1D, an example of the exemplary system 100 being used during the second stage is illustrated. The tag 112 associated with an asset 110 transmits, through its transmitter 114 a signal that is detected directly by a receiver 132 of a device detector 130. A signal characteristic is measured by the receiver 132 and transmitted to the processor 133, which can compute a precise location of the asset 110 based on the signal characteristics measured by its receiver 132. The precise location can be used to convey to the user an indication of the asset's location, for instance by producing a hot-cold type graphical user interface on a monitor 134 of the device, for instance, as illustrated in FIGS. 3J to 3L.

With reference to FIG. 1E, a diagram of an exemplary data flow 102 of one of the systems described in is shown, in accordance with an embodiment. Broadly described, mobile telecommunication antennae 114 transmit signals for the benefit of an RTLS system 120 and a mobile device 130, allowing a user 105 to be guided towards and eventually reach the target 107.

A network of antennae with a known position 122 detect signals emitted by mobile telecommunication antennae 114, each associated with a chip that has properties 113 linked to it, including for instance an identifier such as a unique identifer.

The RTLS 120 collects and analyzes data received by the network of antennae 122. The RTLS system, moreover, requests the position of each antenna of the network.

In a first stage, a user requests position of an object 137, for instance via parameters unique to the mobile telecommunication chip attached to the object. The RTLS system 120 provides an estimation of the position of the mobile antenna of the chip attached to the object 127.

With the approximate location 127 provided by the RTLS 120, the user 105 is able to move towards the target. Eventually, in a second stage, a mobile device 130 of the user will enter within the range of the asset. As soon as it is in range, the mobile device 130 guides the user towards the antenna 133. If the user moves away from the target too much, they can rely on the RTLS system to provide an estimated position once more. Eventually, with the guidance 133 of the mobile device 130, the user 105 will reach the target 107.

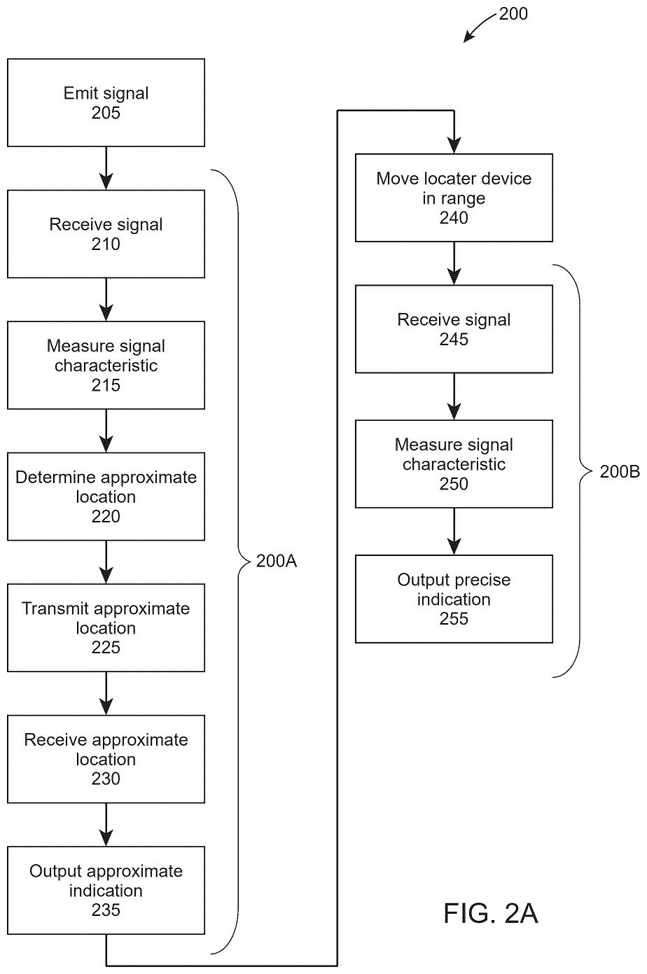

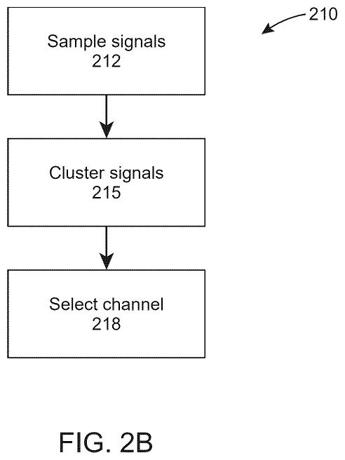

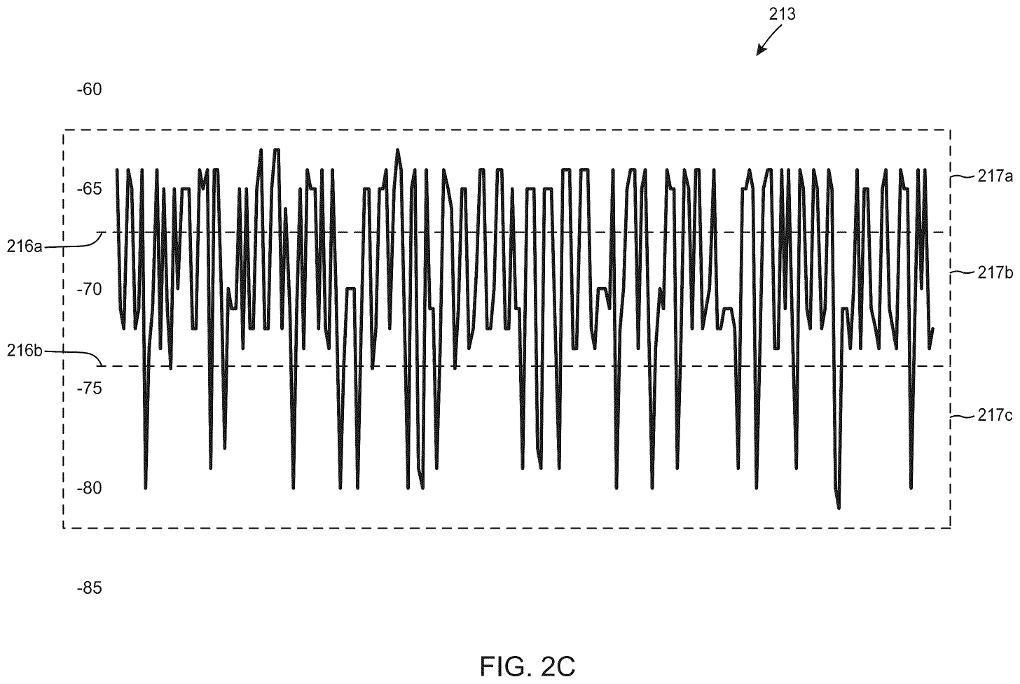

With reference to FIG. 2A, a flowchart of an exemplary method 200 for assisting a user in locating an asset is shown. Broadly described, a transmitter of an asset emits a signal 205. In a first method stage 200A, the signal is received and processed by a RTLS 210-225 in order to provide the user with an approximate indication 230-235. The user can then move to the vicinity of the asset 240 and, in a second method stage 200B, use a locator device to obtain a precise indication 245-255.

At any given time, each asset in the system is configured to emit a signal at a set frequency, or includes a tag configured to emit the signal. When a user wishes to locate an asset, the signal emission is the first step 205. Periodic emission of the signal continues throughout the performance of method 200.

The emitted signal is received by one or more receivers of a RTLS in step 210, and at least one characteristic of the signal is measured in step 215, including for instance fine time measurement, AoA and/or RSSI, or any signal characteristic discussed above. The measured characteristic(s) are used by the RTLS to determine an approximate location of the asset in step 220. In step 225, this approximate location is transmitted for the user's benefit, for instance, to a user device such as a workstation.

The user device receives the approximate location in step 230 and uses it in step 235 to compute and output an approximate indication to assist the user in moving to the vicinity of the asset in step 240 in order to locate it using a locator device. In some embodiments, the aforementioned user device and the locator device can be the same device, and can be configured to assist continuously the user in moving towards the asset vicinity.

When the locator device enters within the range of the asset, it receives the signal in step 245, and also measures at least one characteristic of the signal in step 250. The characteristic(s) are then used in step 255 to compute and output a precise indication to assist the user in locating the asset.

In some embodiments, an asset can be equipped with a transmitter configured to broadcast radio signals over a plurality of channels. With reference to FIGS. 2B and 2C, an exemplary method 210 for receiving a radio signal from an asset with such a transmitter to be used in assisting a user locating said asset and an exemplary illustration of the RSSI of a plurality of signals broadcast over a plurality of channels over time are shown. As examples only, BLE™ can offer three advertisement channels, and Wi-Fi™ can offer ten or eleven. As explained above, radio wave propagation characteristics such as the RSSI associated with a signal received on one frequency can differ substantially from that of a signal on another frequency, even if emitted at the same power level and from the same location. Therefore, using the RSSI across all channels can lead to degraded localization accuracy. Nonetheless, not all transmitters are configured to provide an indication of which channel they are transmitting a signal over, which makes using a method such as method 210, for instance to replace step 210 of method 200 shown in FIG. 2A, useful to increase the accuracy of the asset position estimated by a RTLS.

This approach can advantageously introduce a game-changing improvement in geolocation precision, as it enables real-time channel adaptation based on environmental conditions, optimizing the reliability and accuracy of asset tracking within complex indoor and near-indoor settings.

Method 210 includes a step 212 of surveying, sampling and/or aggregating signal characteristics such as the RSSI of radio signals over a predefined or configurable time period to accumulate sufficient data for accurately inferring the channel to which each RSSI signal belongs for hardware or solution that do not identify the channel on which the signal was detected. In some embodiments, the time period is defined as a duration, for instance, two minutes. In some embodiments, the time period is defined as a number of signals, for instance twenty or thirty signals. In some embodiments, the time period is defined based on both a duration and a number of signals, e.g., a time period of at least two minutes during which at least thirty signals are received. One characteristic or any number of characteristics can be measured for each signal. Line chart 213 illustrates the RSSI of an exemplary 228 signal survey in decibel-milliwatts (dBm), i.e., 1 dBm=1 mW.

Method 220 includes a step 215 of clustering and/or categorizing each signal in a corresponding channel. As an example, if the signal emitter is configured to emit signals in N channels, step 215 can include categorizing each signal in one of N categories, each corresponding to an inferred channel, and/or clustering the signals in N clusters. In some embodiments, statistical techniques are used, to reduce computational resource use, in particular when three channels are used, as is the case for instance with typical BLE™ emitters. Alternatively, four, five, or six channels or more than two, three, four or five channels can be used. As an example, quantiles such as tertiles can be used, such that an equal proportion of signals is placed in each category. As another example, categories can be defined based on standard deviation or z-score thresholds relative to the mean of a distribution. For instance, signals can be categorized into a “low” category for values below μ−σ, a “medium” category for values between μ−σ and μ+σ, and a “high” category for values above μ+σ. In some embodiments, thresholds can be selected such that each category contains approximately one third of the data. As an example only, a “high” category can include values greater than μ+0.43σ, a “medium” category can include values between μ−0.43σ and μ+0.43σ, and a “low” category can include values less than μ+0.43σ. As another example and based on line chart 213, a “high” category 217a can include values greater than a first threshold 216a, a “medium” category 217b can include values between the first threshold 216a and a second threshold 216b, and a “low” category 217c can include values less than the second threshold 216b. In some embodiments, categories can be defined using empirical percentile thresholds derived from the distribution of the data, such as by identifying boundaries that yield equal-sized or application-specific groupings.

Once each signal is categorized into its inferred channel, step 218 can include dynamically selecting the most relevant channel's data group for processing, adapting to the surrounding environment. Given that each antenna channel operates within a distinct signal range and exhibits different propagation behaviours depending on environmental factors, selecting the optimal channel for localization can significantly enhance positioning accuracy. As an example, the signals from the “high” category can be selected, and their RSSIs can be averaged.

With reference to FIGS. 3A to 3L, illustrations of possible views associated with an exemplary GUI of a locator device are shown.

In a first stage, the GUI can be used to select an asset to locate.

As shown in FIGS. 3A to 3C, a view 300A can be used to display a map 310 of the indoor environment with an indication of the approximate location of tracked assets 320 as determined for instance by a RTLS in operative communication with the application displaying the view 300A, for instance, during a first stage. The environment can include different buildings, each with different floors, and therefore the GUI can offer a button 350 that opens a menu 352 for selecting a different building and/or a button 360 that opens a menu 362 for selecting a different floor. As shown in FIG. 3D, the view 300A can additionally or alternatively include a button 340 that can be used to a show a list of tracked assets 342.

With either type of display, the GUI can offer options such as a search bar 330 to search for an asset, for instance by using a unique identifier such as a MAC address or a quick response (QR) code, and/or other information, which can open a search view 332 as shown in FIG. 3E, or by using different filters 334 based on characteristics of the assets, e.g., the name of the manufacturer of the equipment corresponding to the asset, which can open view 336 as shown in FIG. 3F. Search results can then be shown for instance in view 338, as shown in FIG. 3G. The GUI can be used to show additional characteristics of the assets, for instance the remaining battery capacity of a tag used by the asset to emit a signal, as shown in FIGS. 3G to 3L.

Once the desired asset has been found, it can be displayed along with its characteristics for instance with view 322 as shown in FIG. 3H and/or displayed at its approximate location on a zoomed in map 310 of the environment as shown in FIG. 31. Using either interface, the user can then indicate that they want to obtain an indication to assist them in locating the asset.

In a second stage, once the locator device is within the range of the asset, the GUI can be used to provide a view 300B that conveys a precise indication to the user. As an example, the indication can include a distance between the asset and the locator device in a graphical form 370 and/or in a textual and/or numeric form 372, such that the user can move around the approximate location of the asset and determine whether they are moving closer to or further away from the asset. As shown in FIGS. 3J to 3L, as the user moves progressively closer to the asset, the view 300B can update to display an indication of the same, guiding the user in a “hot-cold” fashion towards the asset, thereby improving search efficiency.

One or more systems described herein may be implemented in computer program(s) executed on processing device(s), each comprising at least one processor, a data storage system (including volatile and/or non-volatile memory and/or storage elements), and optionally at least one input and/or output device. “Processing devices” encompass computers, servers and/or specialized electronic devices which receive, process and/or transmit data. As an example, “processing devices” can include processing means, such as microcontrollers, microprocessors, and/or CPUs, or be implemented on FPGAs. For example, and without limitation, a processing device may be a programmable logic unit, a mainframe computer, a server, a personal computer, a cloud-based program or system, a laptop, a personal data assistant, a cellular telephone, a smartphone, a wearable device, a tablet, a video game console or a portable video game device.

Each program is preferably implemented in a high-level programming and/or scripting language, for instance an imperative e.g., procedural or object-oriented, or a declarative e.g., functional or logic, language, to communicate with a computer system. However, a program can be implemented in assembly or machine language if desired. In any case, the language may be a compiled or an interpreted language. Each such computer program is preferably stored on a storage media or a device readable by a general or special purpose programmable computer for configuring and operating the computer when the storage media or device is read by the computer to perform the procedures described herein. In some embodiments, the system may be embedded within an operating system running on the programmable computer.

Furthermore, the system, processes and methods of the described embodiments are capable of being distributed in a computer program product comprising a computer readable medium that bears computer-usable instructions for one or more processors. The computer-usable instructions may also be in various forms including compiled and non-compiled code.

The processor(s) are used in combination with storage medium, also referred to as “memory” or “storage means”. Storage medium can store instructions, algorithms, rules and/or trading data to be processed. Storage medium encompasses volatile or non-volatile/persistent memory, such as registers, cache, RAM, flash memory, ROM, diskettes, compact disks, tapes, chips, as examples only. The type of memory is, of course, chosen according to the desired use, whether it should retain instructions, or temporarily store, retain or update data. Steps of the proposed method can be implemented as software instructions and algorithms, stored in computer memory and executed by processors.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative and non-limiting and it will be understood by persons skilled in the art that other variants and modifications may be made without departing from the scope of the invention as defined in the claims appended hereto.

1. A system for assisting a user in locating an asset comprising a transmitter configured to emit a signal through a two-stage process, the system comprising:
a real time locating system (RTLS) adapted to provide an approximate location of the asset to the user in a first stage, the RTLS comprising:
at least one RTLS receiver adapted to receive the signal and to measure a first characteristic of the signal, and
at least one processor configured to receive from the at least one RTLS receiver the measured first characteristic and to determine therefrom an approximate location of the asset; and
a locator device adapted to provide a precise indication for locating the asset to the user in a second stage, the locator device comprising:
at least one receiver adapted to receive the signal and to measure a second characteristic of the signal and to cause the process to enter the second stage in response to the transmitter of the asset entering detection range,
at least one processor configured to receive from each of the at least one receiver the measured second characteristic and to compute therefrom the precise indication for locating the asset, and
at least one output device adapted to convey the precise indication for locating the asset to the user,
wherein an accuracy radius of the precise indication is less than an accuracy radius of the approximate location.

2. The system of claim 1, wherein the signal is a radio signal.

3. The system of claim 2, wherein the signal is at least one of: an ultra-wideband signal, a Bluetooth™ signal, a Wi-Fi signal, and an RFID signal.

4. The system of claim 2, wherein:
the signal is broadcast over N channels, wherein N>1;
the at least one RTLS receiver is configured to survey a plurality of signals emitted by the asset over the N channels during a configurable time period and measure a surveying characteristic of the plurality of signals; and
the at least one processor of the RTLS is configured to categorize the plurality of signals in N categories based on the surveying characteristic and to determine the approximate location based on at least one signal associated with one of the N categories.

5. The system of claim 1, wherein the first characteristic and/or the second characteristic comprise at least one of: fine time measurement, angle of arrival, and signal strength.

6. The system of claim 1, wherein:
the RTLS comprises an RTLS transmitter adapted to transmit the approximate location of the asset to the locator device;
the locator device is adapted to receive the approximate location of the asset from the RTLS; and
the at least one output of the locator device is configured to convey an approximate indication for locating the asset from the approximate location of the asset.

7. The system of claim 6, wherein the at least one receiver of the locator device is configured to cause the process to revert to the first stage in response to the transmitter of the asset exiting the detection range.

8. A two-stage method for assisting a user in locating an asset comprising a transmitter configured to emit a signal, the method comprising:
in a first stage:
receiving, by a real time locating system (RTLS), the signal,
measuring, by the RTLS, a first characteristic of the signal,
determining, by the RTLS, an approximate location of the asset based on the first characteristic,
transmitting, by the RTLS, the approximate location of the asset,
receiving, by a user device, the approximate location, and
outputting, by the user device, a first indication for locating the asset based on the approximate location; and
in a second stage automatically initialized when a locator device is within detection range of the signal:
receiving, by the locator device, the signal,
measuring, by the locator device, a second characteristic of the signal, and
outputting, by the locator device, a second indication for locating the asset based on the second characteristic,
wherein an accuracy radius of the second indication is less than an accuracy radius of the first indication.

9. The method of claim 8, wherein the signal is a radio signal.

10. The method of claim 9, wherein the signal is at least one of: an ultra-wideband signal, a Bluetooth™ signal, a Wi-Fi signal, and an RFID signal.

11. The method of claim 9, wherein the signal is broadcast over N channels, wherein N>1, further comprising the RTLS:
surveying a plurality of signals emitted by the asset over the N channels during a configurable time period and measuring a surveying characteristic of the plurality of signals;
categorizing the plurality of signals in N categories based on the surveying characteristic; and
determine the approximate location based on at least one signal associated with one of the N categories.

12. The method of claim 8, wherein the first characteristic and/or the second characteristic comprise at least one of: fine time measurement, angle of arrival, and signal strength.

13. The method of claim 8, wherein the user device is the locator device.

14. The method of claim 13, further comprising reverting to the first stage in response to the transmitter of the asset exiting the detection range.

15. The method of claim 8, wherein the user device is a workstation and the locator device is a handheld device.

16. A non-transitory computer-readable medium having instructions stored thereon which, when executed by one or more processors of a locator device, cause the one or more processors to:
in a first stage:
receive an approximate location of an asset from a real time locating system (RTLS) configured to estimate the approximate location based on a first characteristic measured by the RTLS in a signal emitted by a transmitter of the asset, and
output a first indication for locating the asset based on the approximate location;
enter a second stage in response to the transmitter of the asset entering detection range of the locator device; and
in the second stage:
receive the signal,
measure a second characteristic of the signal, and
output a second indication for locating the asset based on the second characteristic,
wherein an accuracy radius of the second indication is less than an accuracy radius of the first indication.

17. The computer-readable medium of claim 16, wherein the signal is a radio signal.

18. The computer-readable medium of claim 17, wherein the signal is at least one of: an ultra-wideband signal, a Bluetooth™ signal, a Wi-Fi signal, and an RFID signal.

19. The computer-readable medium of claim 16, wherein the first characteristic and/or the second characteristic comprise at least one of: fine time measurement, angle of arrival, and signal strength.

20. The computer-readable medium of claim 16, wherein the instructions further cause the one or more processors to revert to the first stage in response to the transmitter of the asset exiting the detection range.
